(19) United States
(12) Patent Application Publication
(10) Pub. No.: US 2009/0071254 A1
(43) Pub. Date: Mar. 19, 2009

(54) METHOD AND APPARATUS FOR THE DETECTION OF CRACKS IN THE TEETH OF GENERATOR ROTORS

(76) Inventors: James Knowles, Culcheth (GB); Roland Moser, Zuerich (CH)

Correspondence Address: CERMAK KENEALY VAIDYA & NAKAJIMA LLP, 515 E. BRADDOCK RD, ALEXANDRIA, VA, 22314, US

(21) Appl. No.: 12/212,681

(22) Filed: Sep. 18, 2008

(30) Foreign Application Priority Data
Sep. 18, 2007 (EP) 07116664.9

(51) Int. Cl. G01N 29/04

(52) U.S. Cl. 73/625

(57) ABSTRACT

A method for non-destructive testing the teeth of a high power electrical generator rotor includes the steps of: providing a plurality of ultrasonic pulse echo transducers (22, . . . ,25) being arranged in an array (20), and being positioned and aligned in such a way as to provide a range of different inspection angles for the tooth geometry; positioning the array (20) on top of the rotor tooth; exciting at least one of the plurality of ultrasonic pulse echo transducers (22, . . . ,25) to produce a transmission beam for the interrogation of wedge angle on the underside of the tooth; and conditioning the acquired data from the at least one of the plurality of ultrasonic pulse echo transducers (22, . . . ,25) to capture reflection from the flaws within the tooth.

This application claims priority under 35 U.S.C. §119 to EP application no. 07116664.9, filed 18 Sep. 2007, the entirety of which is incorporated by reference herein.

### BACKGROUND

1. Field of Endeavor

The present invention generally relates to high power electrical generators. It relates especially to a method and apparatus for the detection of cracks in the teeth of generator rotors.

2. Brief Description of the Related Art

Generator rotors are manufactured from forged steel and these are machined with radial slots along the length of the body of the shaft. These radial slots take the conductors for the field windings to produce a desired magnetic field for power generation. In such a convention, the field windings are restrained within the slot by a wedge. These slot wedges are generally a dovetail arrangement but may vary in design depending on the rotor design. The copper conductor pack is held in place by the slot wedge while the rotor is rotating.

Rotor teeth cracks due to fretting between steel wedges and the rotor during low speed barring (loose wedge) have been reported in the past. These flaws seem to appear quite often, so that NDT (Non Destructive Testing) solutions have been developed that allow for the detection and sizing of these cracks.

FIGS. 1 to 3 depict the problem: The rotor 10 of a high power electrical generator includes, at its outer circumference, a plurality of axial teeth 15, which are separated by winding slots. The winding slots receive a winding 11, which is fixed within the slot by a wedge 14. The winding 11 is connected by a field lead 12 and a respective connector 13. As can be seen in FIG. 3, there is a crack zone 16 at the edge of the tooth 15, where the tooth interacts with the wedge 14. In a first stage A, there is a fretting initiation at this edge, which results in a crack, which grows initially in a second stage B. In a third stage C, the crack grows around the radius of the edge to include the whole T-slot in a fourth stage D. Finally, the crack grows into the body of the rotor 10 in a fifth stage E.

Most of the solutions proposed so far detect the cracks with the wedge 14 and the winding 11 removed. The removal of wedges and windings is very costly and time-consuming.

One document (EP-A1-1 777 513) proposes a solution that allows for detection on the assembled rotor, using a phased array ultrasonic technology. FIG. 4 reproduces FIG. 9 of this document: Here, a phased array 17 of ultrasonic transducers is used to generate a scanning beam for inspection of the crack zone 16 within the tooth 15′ of a rotor 10′.

However, using a phased array requires sophisticated electronic equipment for defining and changing the beam direction and extracting the useful data from the signals received by the phased array.

### SUMMARY

One of numerous aspect of the present invention includes method and apparatus for the detection of cracks in the teeth of generator rotors, which have a simple measuring configuration, are easy to use, and use simple methods for collecting and processing the data.

An exemplary method embodying principals of the present invention comprises the steps of: providing a plurality of ultrasonic pulse echo transducers being arranged in an array, and being positioned and aligned in such a way as to provide a range of different inspection angles for the tooth geometry, positioning the array on top of the rotor tooth, exciting at least one of said plurality of ultrasonic pulse echo transducers to produce a transmission beam for the interrogation of wedge angle on the underside of the tooth, and conditioning the acquired data from said at least one of said plurality of ultrasonic pulse echo transducers to capture reflection from the flaws within the tooth.

According to one embodiment of the invention, the conditioned acquired data is displayed on a display.

According to another embodiment of the invention, the various ultrasonic pulse echo transducers of said array are excited sequentially.

According to another embodiment of the invention, the tooth is fully inspected by moving the array of ultrasonic pulse echo transducers along the entirety of the tooth in the direction of the rotor axis.

According to another embodiment of the invention, the array of ultrasonic pulse echo transducers is aligned to the axial direction of the rotor tooth.

According to another embodiment of the invention, the array of ultrasonic pulse echo transducers is coupled to the tooth face with a coupling medium.

According to another embodiment of the invention, the array of ultrasonic pulse echo transducers is moved along the upper surface of the rotor tooth by means of a semiautomatic or fully automatic device, especially a robot.

According to another embodiment of the invention, the device for moving the pulse-echo transducer array carries an electronic encoder, which in combination with a sequential excitation of each transducer within the array, allows for data acquisition throughout the whole length of the rotor tooth.

According to another embodiment of the invention, the array of ultrasonic pulse echo transducers is rotated to allow inspection of the opposite side of the tooth.

According to another embodiment of the invention, two arrays of ultrasonic pulse echo transducers are positioned and moved in unity along the length of the tooth as to provide full inspection of each tooth in one turn.

Exemplary apparatus embodying principles of the present invention comprises: a plurality of ultrasonic pulse echo transducers being arranged in an array, and being positioned and aligned in such a way as to provide a range of different inspection angles for the tooth geometry, and a data unit for conditioning data acquired from said plurality of ultrasonic pulse echo transducers, said data unit being connected to said array of ultrasonic pulse echo transducers.

According to one embodiment of the invention, said plurality of ultrasonic pulse echo transducers is mounted in one housing.

According to another embodiment of the invention, each ultrasonic pulse echo transducers has its own transducer wedge and acoustic coupling face and is arranged to provide both transmission and reception at a different predetermined angle.

According to another embodiment of the invention, a device is provided, that carries the pulse-echo transducer array along the upper surface of the rotor tooth.

According to another embodiment of the invention, said device is a semiautomatic or fully automatic device, especially a robot.

According to another embodiment of the invention, said device carries an electronic encoder.

### BRIEF DESCRIPTION OF THE DRAWINGS

The subject matter of the invention will be explained in more detail in the following text with reference to preferred exemplary embodiments, which are illustrated in the attached drawings, in which:

FIG. 1 shows a typical rotor of a high power electrical generator;

FIG. 2 shows a simplified drawing of the rotor;

FIG. 3 shows the crack propagation in the tooth of a rotor according to FIG. 1 or 2;

FIG. 4 reproduces FIG. 9 of a prior art document (EP-A1-1 777 513);

FIG. 5 shows a perspective view of an embodiment of the detection system according to the invention;

FIG. 6 shows an embodiment of the pulse echo array according to the invention;

FIG. 7 shows an actual measuring system according to the invention on a model tooth; and

FIG. 8 shows a data unit of a measuring system according to the invention displaying a measuring curve, which shows the presence of a crack.

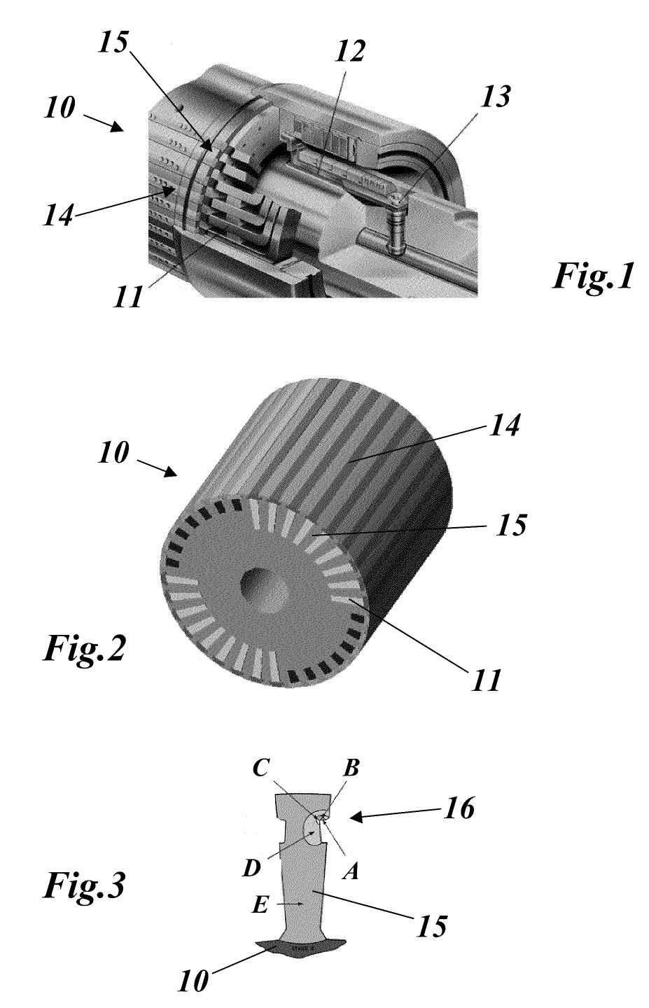

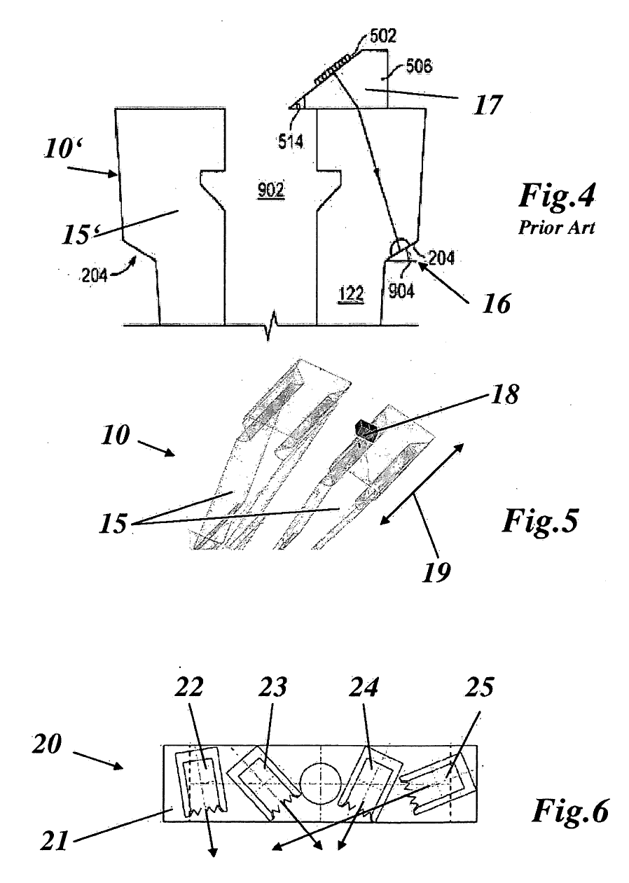

### DETAILED DESCRIPTION OF EXEMPLARY EMBODIMENTS

This disclosure describes a novel ultrasonic approach that takes advantage of the simpler and compacter ultrasonic pulse-echo technology compared to the phased array approach of the prior art (EP-A1-1 777 513).

The new approach is not only capable of detection fretting cracks inside the assembled rotor, but is proven compact enough for in-situ measurement, i.e., it fits into the confined space of the air-gap between rotor and stator, hence allowing for a condition assessment of generator rotors without even removing the rotor from the stator.

Methods and apparatus in accordance with principles of the present invention can be easily applied in combination with existing deployment robots and mechanisms, and are especially capable of preventing fatal failure due to age related cracking.

An exemplary system for inspecting generator rotors includes a pulse echo ultrasound transducer array (see 18 in FIG. 5), that provides a range of active elements with specific angles so arranged to best provide the inspection of the wedge angle face.

As can be seen in FIG. 6, the sensor array or system 20 includes a number of ultrasonic transducers 22, . . . ,25 mounted in one housing (array) or body 21 of, e.g., bulk acrylic. Each of the ultrasonic transducers 22, . . . ,25 is configured with specific beam angles (see arrows in FIG. 6) and to be excited in a sequence to produce a transmission beam for the interrogation of the wedge angle on the underside of the tooth 15. The sensor array 20 carries a number of transducers 22, . . . ,25 (four in the embodiment of FIG. 6) positioned and aligned in such a way as to best provide a range of inspection angles for the tooth geometry. The pulse echo transducers 22, . . . ,25 are so arranged as to best transmit and capture any reflections from cracks.

Each transducer element 22, . . . ,25 has its own transducer wedge and acoustic coupling face and is arranged to provide both transmission and reception at a predetermined angle. FIG. 5 shows the placement of the pulse-echo sensor array 18 and the inspection zone below.

The array 18 or 20 is positioned on top of the rotor tooth 15 and aligned to the axial direction of the rotor tooth 15, being coupled to the tooth face with a suitable coupling medium. One tooth 15 is fully inspected by moving the pulse-echo array 18 or 20 along the entirety of the tooth 15 in the direction of the rotor axis (scan direction 19 in FIG. 5).

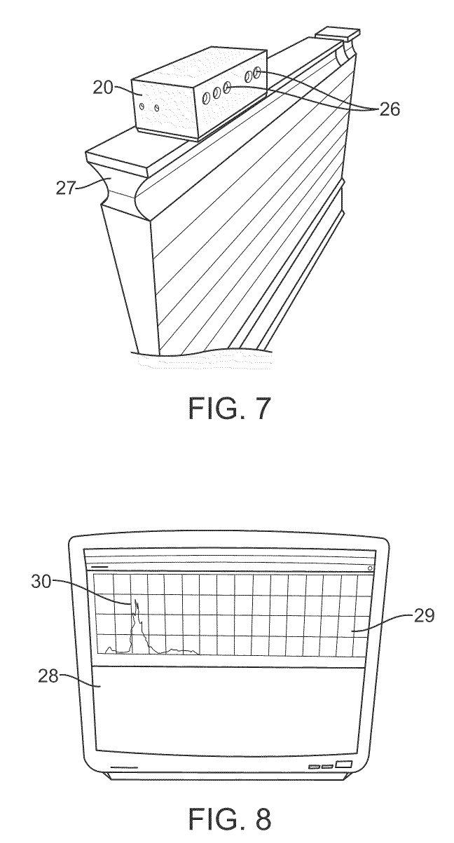

The device, that carries the pulse-echo transducer array 18 or 20 along the upper surface of the rotor tooth 15, can be a manually, semiautomatic, or fully automatic device (i.e., a robot), carrying an electronic encoder. Such an encoder, in combination with a sequential excitation of each transducer 22, . . . ,25 within the array 18 or 20, allows for data acquisition throughout the whole length of the rotor teeth 15. The acquired data is conditioned by a data unit 28 (FIG. 8), which is connected to the array 20 by connectors 26 (FIG. 7), to capture reflection from the flaws. The resulting curve is displayed on a display 29 to show a crack indicating peak 30. The array 20 can be tested and calibrated by a model tooth 27, which contains artificial cracks.

The array 18 or 20 can be rotated to allow inspection of the opposite side of the tooth 15, or two such devices can be positioned and moved in unity along the length of the tooth 15 as to provide full inspection of each tooth 15 in one turn.

Each of the transducers 22, . . . ,25 can be excited individually or in a sequence to perform data acquisition whilst stationary or dynamically.

Summed up, the system can be characterized by:

An arrangement of pulse echo transducers arranged at specific angles for the interrogation of wedge angles.

A transducer array having individual transceivers so arranged for the detection of fretting cracking.

The ultrasonic beam angles enter the material at predetermined paths and beam angles through the top surface of the rotor tooth.

Acoustic coupling face profiled to suit each rotor design and diameter.

### LIST OF REFERENCE NUMERALS

10,10′ rotor

11 winding

12 field lead

13 connector

14 wedge

15,15′ tooth

16 crack zone

17 phased array

18,20 sensor array (pulse echo)

19 scan direction

21 body (e.g. acrylic)

22, . . . ,25 ultrasonic transducer

26 connector

27 model tooth

28 data unit

29 display

30 crack indicating peak

A, . . . ,E crack growth propagation stage

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A method for non-destructive testing the teeth of a high power electrical generator rotor, the method comprising:
providing a plurality of ultrasonic pulse echo transducers being arranged in an array, and being positioned and aligned in such a way as to provide a range of different inspection angles for the tooth geometry;
positioning the array on top of a rotor tooth;
exciting at least one of said plurality of ultrasonic pulse echo transducers to produce a transmission beam for the interrogation of wedge angle on the underside of the tooth; and
conditioning the acquired data from said at least one of said plurality of ultrasonic pulse echo transducers to capture reflection from the flaws within the tooth.

2. The method as claimed in claim 1, further comprising:
displaying the conditioned acquired data on a display.

3. The method as claimed in claim 1, wherein exciting comprises sequentially exciting the ultrasonic pulse echo transducers of said array.

4. The method as claimed in claim 1, further comprising:
moving the array of ultrasonic pulse echo transducers along the entirety of the tooth in the direction of the rotor axis to fully inspect the tooth.

5. The method as claimed in claim 1, wherein positioning comprises aligning the array of ultrasonic pulse echo transducers to the axial direction of the rotor tooth.

6. The method as claimed in claim 1, further comprising:
coupling the array of ultrasonic pulse echo transducers to the tooth face with a coupling medium.

7. The method as claimed in claim 4, wherein moving comprises moving the array of ultrasonic pulse echo transducers along an upper surface of the rotor tooth by a semiautomatic or fully automatic device.

8. The method as claimed in claim 7, wherein the semiautomatic or fully automatic device for moving the pulse-echo transducer array comprises an electronic encoder, which in combination with a sequential excitation of each transducer within the array, allows for data acquisition throughout the whole length of the rotor tooth.

9. The method as claimed in claim 7, wherein the semiautomatic or fully automatic device comprises a robot.

10. The method as claimed in claim 1, further comprising:
rotating the array of ultrasonic pulse echo transducers to allow inspection of an opposite side of the tooth.

11. The method as claimed in claim 1, wherein providing and positioning comprises providing and positioning two arrays of ultrasonic pulse echo transducers, and further comprising:
moving the two arrays in unity along the length of the tooth to provide full inspection of the tooth in one turn.

12. An apparatus for the non-destructive testing the teeth of a high power electrical generator rotor comprising:
a plurality of ultrasonic pulse echo transducers arranged in an array and being positioned and aligned in such a way as to provide a range of different inspection angles for tooth geometry; and
a data unit in signal communication with the plurality of ultrasonic pulse echo transducers, configured and arranged to condition data acquired from said plurality of ultrasonic pulse echo transducers.

13. The apparatus as claimed in claim 12, further comprising:
a housing;
wherein said plurality of ultrasonic pulse echo transducers is mounted in said housing.

14. The apparatus as claimed in claim 12, wherein each ultrasonic pulse echo transducers has a transducer wedge and acoustic coupling face and is arranged to provide both transmission and reception at a different predetermined angle.

15. The apparatus as claimed in claim 12, further comprising:
a device configured and arranged to carry the pulse-echo transducer array along an upper surface of the rotor tooth.

16. The apparatus as claimed in claim 15, wherein said device comprises a semiautomatic or fully automatic device.

17. The apparatus as claimed in claim 16, wherein said device comprises an electronic encoder.

18. The apparatus as claimed in claim 15, wherein the semiautomatic or fully automatic device comprises a robot.
